(19) United States
(12) Patent Application Publication
(10) Pub. No.: US 2026/0253021 A1
(43) Pub. Date: Aug. 27, 2026

(54) INFORMATION PROCESSING SYSTEM, INFORMATION PROCESSING DEVICE, INFORMATION PROCESSING METHOD, AND PROGRAM

(71) Applicant: AERONEXT INC., Tokyo (JP)

(72) Inventors: Shuji KAWAI, Tokyo (JP); Tadanari HIGUCHI, Gifu (JP); Keisuke TOJI, Tokyo (JP); Takuya HORI, Tokyo (JP)

(21) Appl. No.: 18/879,250

(22) PCT Filed: Jun. 28, 2023
(86) PCT No.: PCT/JP2023/024023

§ 371 Date: Dec. 27, 2024

(30) Foreign Application Priority Data
Jun. 30, 2022 (JP) 2022-105547

(51) Int. Cl. G06Q 10/083

(52) U.S. Cl. CPC G06Q 10/08355

(57) ABSTRACT

Provided is an information processing system including: a control unit that generates one or more delivery plans including delivery routes and delivery means of a package, and a candidate determination unit that determines, as candidates of a service provider, one or more users estimated to be able to provide a service for collection and delivery of the package, in which upon approval of one user, as the service provider, from among the users determined as the candidates, the control unit selects and approves one of the delivery plans to a package collection point of the service provider from among the generated delivery plans.

### FIELD

The present invention relates to an information processing system, an information processing device, an information processing method, and a program.

### BACKGROUND

In recent years, demand of logistics, such as package delivery or collection, has sharply increased because of proliferation of e-commerce, changes in consumer demand or social environments, and the like. With the sharp increase in demand, a labor shortage in logistics has become a fundamental challenge for stably maintaining the logistics function itself. Therefore, various techniques have been examined for efficient delivery or collection of packages. For example, Patent Literature 1 discloses a technique that, in logistics of parcel to be delivered, acquires the loading capacity of each of one or a plurality of circulation services circulating through three bases, and determines whether to change the operation plan of the circulation services based on the acquired loading capacity. Such traditional delivery systems employ a hub-and-spoke system in which packages are collected in a base, such as a large warehouse, and then delivered from the base to various locations.

Further, as new bearers supporting logistics in recent years, provision of delivery services by workers who contract one-time jobs through the Internet (so-called “gig workers”) has begun to be used in, for example, food delivery services in which users request delivery of food or the like by using smartphones or the like.

### CITATION LIST

### Patent Literature

Patent Literature 1: Japanese Patent Application Laid-open No. 2020-52525

### SUMMARY

### Technical Problem

However, there is a desire for a technique that can further improve the efficiency of delivery or collection of packages.

The present invention is designed in view of the aforementioned circumstances, and it is an object thereof to provide a novel and improved information processing system, information processing device, information processing method, and program capable of further improving the efficiency of delivery or collection of packages.

### Solution to Problem

In order to solve the abovementioned problems, with an aspect of the present invention, provided is an information processing system including: a control unit that generates one or more delivery plans including delivery routes and delivery means of a package; and a candidate determination unit that determines, as service provider candidates, one or more users estimated to be able to provide a service for collection and delivery of the package, in which upon approving, as the service provider, one user from among the users determined as the candidates, the control unit selects and approves one of the delivery plans to a package collection point of the service provider from among the generated delivery plans.

Moreover, in order to solve the abovementioned problems, with another aspect of the present invention, provided is an information processing device including: a control unit that generates one or more delivery plans including delivery routes and delivery means of a package; and a candidate determination unit that determines, as service provider candidates, one or more users estimated to be able to provide a service for collection and delivery of the package, in which upon approving, as the service provider, one user from among the users determined as the candidates, the control unit selects and approves one of the delivery plans to a package collection point of the service provider from among the generated delivery plans.

Moreover, in order to solve the abovementioned problems, with another aspect of the present invention, provided is an information processing method executed by a computer, the information processing method including: generating one or more delivery plans including delivery routes and delivery means of a package; determining, as service provider candidates, one or more users estimated to be able to provide a service for collection and delivery of the package; and selecting and approving one of the delivery plans to a package collection point of the service provider from among the generated delivery plans upon approving, as the service provider, one user from among the users determined as the candidates.

Moreover, in order to solve the abovementioned problems, with another aspect of the present invention, provided is a program that causes a computer to function as the computer including: a control unit that generates one or more delivery plans including delivery routes and delivery means of a package; and a candidate determination unit that determines, as service provider candidates, one or more users estimated to be able to provide a service for collection and delivery of the package, in which upon approving, as the service provider, one user from among the users determined as the candidates, the control unit selects and approves one of the delivery plans to a package collection point of the service provider from among the generated delivery plans.

As described above, the present invention is capable of further improving the efficiency of delivery or collection of packages.

### BRIEF DESCRIPTION OF DRAWINGS

FIG. 1 is an explanatory diagram for describing an overview of an information processing system according to an embodiment.

FIG. 2 is an explanatory diagram for describing an example of delivery slots according to the present embodiment.

FIG. 3 is an explanatory diagram for describing an example of a functional configuration of a server 30 according to the present embodiment.

FIG. 4 is an explanatory diagram for describing an example of a functional configuration of an information terminal 50 according to the present embodiment.

FIG. 5 is a flowchart diagram for describing an operation processing example of determining service provider candidates and approving a delivery plan by the information processing system according to the present embodiment.

FIG. 6 is an explanatory diagram for describing an example of a hardware configuration of the server 30 according to the present embodiment.

### DESCRIPTION OF EMBODIMENTS

The contents of an embodiment of the present invention will be listed and described. An information processing system and the like according to the embodiment has the following configurations.

### Item 1

An information processing system including:
a control unit that generates one or more delivery plans including delivery routes and delivery means of a package; and
a candidate determination unit that determines, as candidates of a service provider, one or more users estimated to be able to provide a service for collection and delivery of the package, in which
upon approval of one user, as the service provider, from among the users determined as the candidates, the control unit selects and approves one of the delivery plans to a package collection point of the service provider from among the generated delivery plans.

### Item 2

The information processing system according to Item 1, further including
a notification generation unit that generates notification of an offer for the service provider, in which
the control unit approves the user determined as the candidate as a service provider, based on response of the user to the offer.

### Item 3

The information processing system according to Item 1, in which
the control unit acquires a possible condition for service provision that indicates a condition in a state where each of the users is able to perform service provision, and
selects a user satisfying the possible condition for service provision from among the users determined as the candidates and approves the user as the service provider.

### Item 4

The information processing system according to any one of Item 2 or 3, in which the candidate determination unit determines users estimated to be able to provide the service as service provider candidates based on a package collecting time zone at the package collection point, current locations of the users, travel means of the users, and determined schedule status for service provision of the users.

### Item 5

The information processing system according to Item 4, in which
the candidate determination unit estimates locations of the users by time and travel routes of the users from the current locations to the package collection point based on the current locations and the determined schedule status for service provision of the users, and
determines one or more users estimated to be able to provide the service as service provider candidates based on the estimated locations and the estimated travel routes of the users.

### Item 6

The information processing system according to Item 5, in which the candidate determination unit determines one or more of the users in order of shorter travel route to the package collection point as the service provider candidates from among the users estimated to be able to travel to the package collection point within the package collecting time zone and to be able to perform delivery of the package to a destination.

### Item 7

The information processing system according to Item 5, in which the candidate determination unit determines one or more of the users in order of earliest estimated arrival time to the package collection point as the service provider candidates from among the users estimated to be able to travel to the package collection point within the package collecting time zone and to be able to perform delivery of the package to a destination.

### Item 8

The information processing system according to Item 5, in which
the candidate determination unit acquires a possible standby time indicating a time period that allows the package to stand by at the package collection point, determined based on a control temperature zone of the package, and
determines the users estimated to be able to arrive at the package collection point within a time period between an estimated arrival time of the package at the package collection point and elapse of the possible standby time, as the service provider candidates.

### Item 9

The information processing system according to any one of Items 5 to 8, further including
a notification generation unit that generates notification of an offer for the service provider, in which
the control unit notifies one user, from among the users determined as the candidates, of the offer.

### Item 10

The information processing system according to any one of Items 5 to 8, further including
a notification generation unit that generates notification of an offer for the service provider, in which
the control unit notifies one or more predetermined number of users, from among the users determined as the candidates, of the offer.

### Item 11

The information processing system according to Item 10, in which the control unit approves one of the users who responded to the offer at earliest, as the service provider, from among the users determined as the candidates and notified of the offer.

### Item 12

The information processing system according to Item 11, in which the control unit approves the user who responded to the offer within a predetermined time limit after notification of the offer, as the service provider.

### Item 13

The information processing system according to Item 12, in which when none of the users respond to the offer within a certain time period after notification of the offer, the candidate determination unit determines the service provider candidate for another delivery plan from which the package collection point and the package collecting time zone are different, and
the control unit approves the user determined as the candidate, as a service provider, based on response of the user to the offer.

### Item 14

The information processing system according to Item 12, in which when none of the users responding to the offer within a certain time period after notification of the offer, the control unit selects and approves another delivery plan that does not include collection and delivery of the package by the service provider.

### Item 15

The information processing system according to Item 13 or 14, in which
the control unit acquires availability of delivery slots divided by predetermined time slots indicating time zones in which delivery by the delivery means is possible, and possible delivery locations indicating a point where delivery by the delivery means is possible, and
generates the delivery plan by designating the delivery means, the delivery slot, the possible delivery location, and the delivery route based on availability of the delivery slots and the possible delivery locations in each of the delivery means.

### Item 16

The information processing system according to Item 15, in which the control unit generates the delivery plan based on a weather forecast for the delivery route.

### Item 17

The information processing system according to item 16, in which the delivery means includes an unmanned vehicle.

### Item 18

The information processing system according to item 17, in which the unmanned vehicle includes a mobile body that autonomously travels on a land route or an aircraft that autonomously flies on an air route.

### Item 19

An information processing device including:
a control unit that generates one or more delivery plans including delivery routes and delivery means of a package; and
a candidate determination unit that determines, as candidates of a service provider, one or more users estimated to be able to provide a service for collection and delivery of the package, in which
upon approval of one user, as the service provider, from among the users determined as the candidates, the control unit selects and approves one of the delivery plans to a package collection point of the service provider from among the generated delivery plans.

### Item 20

An information processing method executed by a computer, the information processing method including:
generating one or more delivery plans including delivery routes and delivery means of a package;
determining, as candidates of a service provider, one or more users estimated to be able to provide a service for collection and delivery of the package; and
selecting and approving one of the delivery plans to a package collection point of the service provider from among the generated delivery plans upon approval of one user, as the service provider, from among the users determined as the candidates.

### Item 21

A program that causes a computer to function as the computer including:
a control unit that generates one or more delivery plans including delivery routes and delivery means of a package; and
a candidate determination unit that determines, as candidates of a service provider, one or more users estimated to be able to provide a service for collection and delivery of the package, in which
upon approval of one user, as the service provider, from among the users determined as the candidates, the control unit selects and approves one of the delivery plans to a package collection point of the service provider from among the generated delivery plans.

Hereinafter, a preferable embodiment of the present invention will be described in detail with reference to the accompanying drawings. In the present specification and drawings, duplicate explanations of structural components having substantially identical functional configuration will be omitted by applying the same reference signs thereto.

Further, in the present specification and drawings, a plurality of structural components having substantially identical functional configuration may be distinguished by applying different numbers or alphabetic characters after the same reference signs. However, if there is no particular need to distinguish each of the components having substantially identical functional configuration, only the same reference sign is applied to each of the components.

### 1. Overview of Information Processing System according to Embodiment of Present Invention

An embodiment of the present invention relates to an information processing system that can further improve the efficiency of delivery or collection of packages. More specifically, the information processing system according to an embodiment of the present invention is capable of implementing a more efficient delivery system including delivery by a delivery means such as an unmanned vehicle and a service provider such as a gig worker, instead of or in addition to delivery by a hub-and-spoke system such as a traditional delivery system.

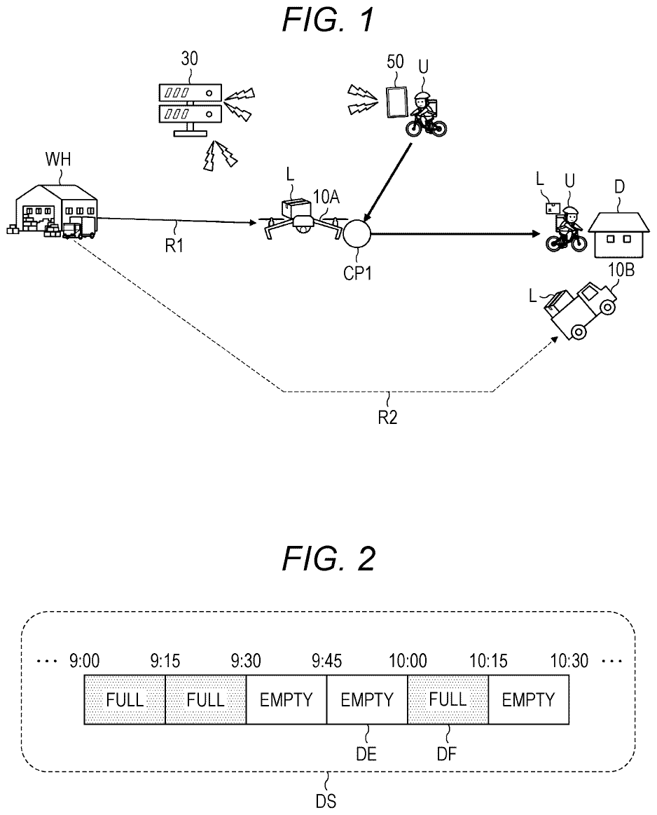

FIG. 1 is an explanatory diagram for describing an overview of the information processing system according to the present embodiment. As illustrated in FIG. 1, the information processing system according to the present embodiment includes a mobile body 10, a server 30, and an information terminal 50. The mobile body 10, the server 30, and the information terminal 50 are connected to each other via a network.

As illustrated in FIG. 1, the information terminal 50 is a terminal used by a service provider U who provides a service for collecting a package L transported by the mobile body 10 to a package collection point CP1 and delivering the package L to a delivery destination D. The service provider U carries the information terminal 50. The service provider U responds to an offer for the service provision of the package collection and delivery, which is notified from the server 30 to the information terminal 50, and provides the service for collection and delivery (delivery and collection) of the package L. Such a service provider U is generally referred to as so-called a gig worker.

### Mobile Body 10

The mobile body 10 is a mobile body used in delivery work such as delivery or collection of the package L. For example, the mobile body 10 is used when delivering the package L requested to be delivered from a warehouse WH where the package L is stored. Note that the mobile body 10 is not essential in the delivery work, and the delivery may be made on foot along with a cart (for example, a box cart, a basket cart, or the like), for example. A store such as a retail store or a restaurant may be used instead of the warehouse.

The mobile body 10 includes an unmanned vehicle 10A that moves under autonomous control or by remote control. For example, the unmanned vehicle 10A may move by autonomous control using input information such as locations of two points such as a start point (for example, the delivery start location of the package L or the moving start location of an unmanned vehicle 10B) and an end point (for example, the possible delivery point of each delivery means such as a drone stand), or locations of three or more points further including a relay point (for example, the collection location of the package L in case of delivery involving collection of the package L) and a return point (for example, the same location as the moving start location of an unmanned vehicle 10, or a different standby location and the like). Note that the input information used for autonomous control may include various kinds of information such as other via points and delivery routes.

The unmanned vehicle 10A may also be moved by remote control using operation information remotely input by an administrator who manages the unmanned vehicle 10A. For example, the unmanned vehicle 10A may be an aircraft as illustrated in FIG. 1. The aircraft may be a drone that flies under autonomous control or an unmanned aerial vehicle (UAV) that flies under remote control of an administrator.

The unmanned vehicle 10A according to the present embodiment is not limited to an aircraft. For example, the unmanned vehicle 10A may be an unmanned ground vehicle (UGV) or the like that travels on a land route, or it may be a vessel traveling on a waterway, such as a seaway or a river.

The mobile body 10 includes a manned mobile body 10B used by a delivery person who delivers or collects the package L. For example, the manned mobile body 10B may be a vehicle (for example, a passenger car, a light truck, a cargo vehicle such as a light van, a motorcycle, a bicycle, a kickboard, or the like) that travels on a land route, as illustrated in FIG. 1. However, the manned mobile body 10B is not limited to a vehicle. For example, the manned mobile body 10B may be an aircraft that flies on an air route, or a vessel traveling on a waterway such as a seaway or a river.

The unmanned vehicle 10A and the manned mobile body 10B may also be mobile bodies that can travel on at least two or more routes out of land route, waterway, and air route.

### Server 30

The server 30 is an example of the information processing device and has a function of receiving a delivery or collection request of a package (hereinafter, delivery request) from a client and generating a delivery plan including information on such as a delivery means and a delivery route of the package. The server 30 also has a function of performing management related to operations of the mobile body 10 based on the generated delivery plan. For example, the server 30 may be a general-purpose computer such as a workstation or a PC, or may also be a cloud server. The method by which the server 30 receives the delivery request is not limited. For example, the server 30 may receive the delivery request by communicating with a smartphone used by a general consumer or an external terminal installed in a store such as a retail store and a restaurant, each of which is not illustrated in FIG. 1. Alternatively, an operator of the server 30 may input the delivery request received from a client into the server 30, and then the server 30 may receive the delivery request.

Such a server 30 generates an aforementioned delivery plan upon receiving the delivery request. At this time the server 30 may generate a plurality of delivery plans from the delivery start location to the end point of the package L, in combination of a plurality of delivery means, delivery routes, and time zones that are different to each other. Further, in one delivery plan, the server 30 may generate a delivery plan in combination of the delivery means such as the unmanned vehicle 10A and the manned mobile body 10B. Furthermore, the server 30 may generate a delivery plan that combines delivery to a possible delivery point (a relay point) by the delivery means with collection and delivery of a package from the possible delivery point to the delivery destination by the service provider U. Note that the possible delivery point is a point to which each of the mobile bodies 10 is capable of performing delivery, and is determined based on a stopping point of the mobile body 10 (for example, for an aircraft, a departure/arrival place prepared in advance) or a responsible area of the delivery person using the mobile body 10. As used herein below, the possible delivery point is also referred to as the package collection point.

In the example illustrated in FIG. 1, the server 30 generates a delivery plan that combines a delivery route R1 in which the unmanned vehicle 10A delivers the package L to the package collection point CP1 with collection and delivery of the package L by the service provider U from the package collection point CP1 to the delivery destination D. Further, the server 30 generates a delivery plan in the delivery route R2, as another delivery plan to the same delivery destination, in which the manned mobile body 10B delivers the package L to the delivery destination D. The server 30 selects and approves any one delivery plan from among the generated delivery plans. Alternatively, if generating one delivery plan, the server 30 approves the one delivery plan.

The server 30 has a matching function of determining service provider candidates to be able to provide a service for collection and delivery of the package L from the package collection point. The server 30 determines the service provider candidates from among a plurality of users registered in advance. Further, the server 30 notifies the users determined as the service provider candidates about an offer for the service provision. Upon any of the users responding to the offer for the service provision, the server 30 can select and approve a delivery plan that combines collection and delivery of the package by the service provider with other delivery means, among the generated delivery plans.

Upon approval of one delivery plan, the server 30 performs management of various schedules for delivery or collection related to the delivery plan, such as designation of a delivery means and reservation of a delivery slot related to the delivery plan. For example, the server 30 may register the delivery schedule related to the delivery or collection of the package L in a delivery slot of the delivery person or the unmanned vehicle 10A delivering the package L. Note that in this specification, the delivery slot indicates a time zone during which delivery can be made by delivery means, such as a delivery person or the unmanned vehicle 10A. Based on the approved delivery plan, the server 30 generates delivery instruction information on the delivery destination or the delivery route to instruct the mobile body 10 or the delivery person. The server 30 may transmit the generated delivery instruction information to the mobile body 10 directly, or to a delivery person terminal (not illustrated) used by the delivery person using the mobile body 10. The mobile body 10 or the delivery person perform delivery and collection of the package L in accordance with the delivery instruction information.

FIG. 2 is an explanatory diagram for describing an example of the delivery slots according to the present embodiment. For example, a daily delivery plan DS of the unmanned vehicle 10B (or the delivery person) is divided into prescribed delivery slots (for example, 15 minutes), and the unmanned vehicle 10B (or the delivery person) delivers, during the time corresponding to the delivery slot, the package L registered for each delivery slot. Such a combination of the delivery plan DS and the delivery slots may be set for each of a plurality of possible delivery point (package collection point) candidates.

For example, a delivery plan DS set at a certain possible delivery point (for example, the package collection point CP1 or the like illustrated in FIG. 1) has two kinds that are: “full” delivery slot (referred to as “full slot DF” hereinafter) indicating that the delivery schedule of the unmanned vehicle 10B (or the delivery person) is already filled; and “empty” delivery slot (referred to as “empty slot DE” hereinafter) indicating that there is an available space in the delivery schedule of the unmanned vehicle 10B (or the delivery person).

### Information Terminal 50

The information terminal 50 is a terminal used by the service provider U. For example, the information terminal 50 may be implemented by a tablet terminal, a smartphone, a cellular phone, a personal handy-phone system (PHS), a personal digital assistant (PDA), a personal computer (PC), or the like.

The information terminal 50 receives the notification of an offer for the service provision of collection and delivery of the package L from the server 30. The service provider U can view the notification of the offer by operating the information terminal 50. Further, the service provider U can operate the information terminal 50 to respond to the offer. When the service provider U performs the operation to respond to the offer at the information terminal 50, the information terminal 50 notifies the server 30 that the service provider U has responded to the offer.

The information terminal 50 has a function of displaying various kinds of information on the offer to the service provider U. For example, the information terminal 50 can display information to the service provider U on the location of the package collection point, a travel route from the current location of the service provider U or from the via point, and the like related to the task of determined service provision.

The overview of the information processing system according to the present embodiment is described heretofore. Subsequently, an example of the functional configurations of the server 30 and the information terminal 50 according to the present embodiment will be described.

### 2. Example of Functional Configuration

### 2-1. Server 30

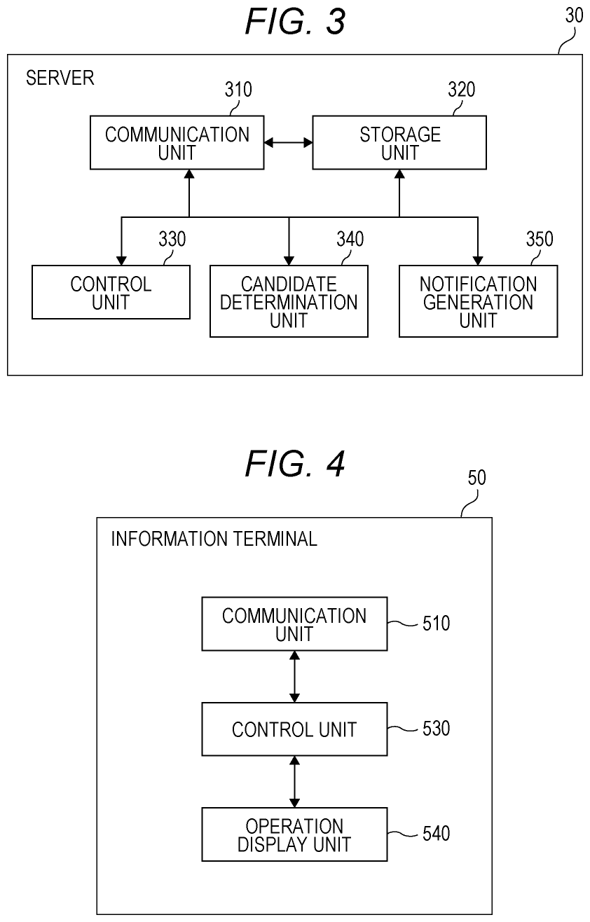

FIG. 3 is an explanatory diagram for describing an example of the functional configuration of the server 30 according to the present embodiment. The server 30 according to the present embodiment includes a communication unit 310, a storage unit 320, a control unit 330, a candidate determination unit 340, and a notification generation unit 350, as illustrated in FIG. 3.

The control unit 330, the candidate determination unit 340, and the notification generation unit 350 include an arithmetic device such as a central processing unit (CPU) or a graphics processing unit (GPU), and their functions can be implemented by expanding a program stored in a read only memory (ROM) into a random access memory (RAM) and executing the program. At this time, a computer-readable recording medium recording the program can also be provided. Alternatively, these blocks may be configured by dedicated hardware or implemented by combining a plurality of pieces of hardware.

Necessary data for calculations by the arithmetic device is appropriately stored by the storage unit 320. The storage unit 320 may be configured by a memory such as a RAM, a hard disk drive, or a flash memory.

### Communication Unit 310

The communication unit 310 performs various types of communication with the mobile body 10, and an external terminal such as the information terminal 50. For example, the communication unit 310 transmits notification of an offer for a service generated by the notification generation unit 350 to the information terminal 50, in accordance with control of the control unit 330. The communication unit 310 also receives notification from the information terminal 50 that the service provider U has responded to the offer for the service. Further, the communication unit 310 receives, from the information terminal 50, location positioning information such as the current location of the service provider U and information on execution status of the current service provision task that is input to the information terminal 50 by operations of the service provider U. The communication unit 310 receives delivery requests by communicating with smartphones used by general consumers (clients) as described above, or with external terminals installed in stores and the like.

### Storage Unit 320

The storage unit 320 holds software and various kinds of data. For example, the storage unit 320 holds information on users who are registered in advance and able to provide package collection and delivery services. The user information includes, for example, travel means used by each of the service providers U and areas in which the service can be provided. The storage unit 320 also holds various kinds of information related to generation of delivery plans. For example, the storage unit 320 holds information on delivery means, possible delivery locations for each delivery means, availability of each possible delivery location, availability of delivery slots for each delivery means, and delivery requests (for example, location information such as a delivery address included in the delivery request, and the type and the number of packages L).

### Control Unit 330

The control unit 330 controls the overall operation of the server 30. The control unit 330, for example, controls the communication unit 310 to transmit the notification of an offer for services to the information terminal 50. The control unit 330 has a function of generating one or more delivery plans for delivery of the package L upon reception of a delivery request of the package L by the communication unit 310. The control unit 330 also has a function of approving, as a service provider, a user determined as a candidate of the service provider by the candidate determination unit 340 (described below), based on response of the user to the offer of the service provision. Upon approving one user as the service provider, the control unit 330 selects and approves one delivery plan among the generated delivery plans to the possible delivery location of the service provider (the package collection point as seen from the service provider U).

The control unit 330 refers to the storage unit 320 to acquire availability of the delivery slots for each delivery means and the possible delivery locations for each delivery means. The control unit 330 generates delivery plans by designating delivery means, delivery slots, possible delivery locations, and delivery routes based on the acquired availability of the delivery slots and the possible delivery locations for each delivery means. At this time, the control unit 330 may further generate delivery plans based on a weather forecast for the above delivery route. For example, if the weather forecast for a delivery route indicates bad weather, the control unit 330 may designate other delivery means for the delivery route that is not an autonomous mobile body that travels on an air route affected by the bad weather (especially weather with high-speed wind).

Upon selecting and approving one delivery plan, the control unit 330 generates delivery instruction information including information on designation of the delivery means and the delivery slot based on the delivery plan. Further, the control unit 330 may transmit delivery instruction information to a delivery person terminal, which is not illustrated in FIG. 1, used by the delivery person. Alternatively, the control unit 330 may communicate directly with the unmanned vehicle 10A and transmit the delivery instruction information. Alternatively, if there is an administrator remotely operating the unmanned vehicle 10A, the control unit 330 may transmit the delivery instruction information to an information terminal (for example, a PC) used by the administrator. This causes the package L to be delivered based on the delivery plan generated and approved by the server 30.

### Candidate Determination Unit 340

The candidate determination unit 340 has a function of determining one or more users estimated to be able to provide the service of package collection and delivery from the package collection point as service provider candidates. More specifically, when the delivery plans generated by the control unit 330 include a delivery plan that combines delivery by the mobile body 10 to a possible delivery location with package collection and delivery by a service provider from the possible delivery location (package collection point), the candidate determination unit 340 determines service provider candidates for the above delivery plan from among the users registered in advance. Hereinafter, “user” herein refers to a user registered in advance as a potential service provider candidate. The user registration may be performed by transmitting information on the user entered by each user operating the information terminal 50 to the server 30 and storing the information in the storage unit 320. Alternatively, the storage unit 320 may also hold user information in advance.

The candidate determination unit 340 determines users estimated to be able to provide the service as service provider candidates based on a package collecting time zone at the package collection point, current locations of the users, travel means of the users, and determined schedule status for service provision of the users (including, for example, distance between the delivery destination and the current location, and required time). The package collecting time zone can be determined in accordance with the delivery slots of the mobile body 10 and the availability of the package collection point when the delivery plan is generated by the control unit 330. Alternatively, if the delivery request of the package L includes collection of the package L, the package collecting time zone may be a desired collection time. The candidate determination unit 340 acquires the current location of each user and the determined schedule status for service provision of each user from the information terminal 50 via the communication unit 310.

In the process of determining service provider candidates, the candidate determination unit 340 estimates current locations of the users by time and travel routes of the users from the current locations to the package collection point based on the current locations and the determined schedule status for service provision of the users. The candidate determination unit 340 determines a predetermined number of users estimated to be able to provide the service as service provider candidates based on the estimated locations and travel routes. At this time, the maximum number of users to be determined as candidates may be set in advance by the operator of the server 30.

For example, the candidate determination unit 340 may determine the users as the service provider candidates in order of shortest travel route from the current location to the package collection point, from among the users estimated to be able to travel to the package collection point and deliver the package to the delivery destination during the package collecting time zone. Alternatively, the candidate determination unit 340 may determine one or more users as the service provider candidates in order of earliest estimated arrival time at the package collection point. Alternatively, if the package L is a package for which a control temperature zone is set, for example, when the package L is a product requiring refrigeration, the candidate determination unit 340 may acquire a possible standby time indicating a time during which the package L can stand by at the package collection point, which is determined based on the control temperature zone. The possible standby time may be determined in advance for each type of the packages L and held in the storage unit 320. The candidate determination unit 340 may determine the users estimated to be able to arrive at the package collection point within the time period between the estimated arrival time of the package at the package collection point and elapse of the possible standby time, as the service provider candidates.

### Notification Generation Unit 350

The notification generation unit 350 has a function of generating the notification of an offer for the service provider. The notification of an offer generated by the notification generation unit 350 is sent to the information terminal 50 used by the users determined as service provider candidates, in accordance with control of the control unit 330. Alternatively, the server 30 may include a display unit, which is not illustrated in FIG. 3. In that case, the notification of an offer may be displayed on the display unit in accordance with control of the control unit 330.

An example of the functional configuration of the server 30 according to the present embodiment is described heretofore with reference to FIG. 3. Subsequently, an example of the functional configuration of the information terminal 50 according to the present embodiment will be described with reference to FIG. 4.

### 2-2. Information Terminal 50

FIG. 4 is an explanatory diagram for describing an example of the functional configuration of the information terminal 50 according to the present embodiment. As illustrated in FIG. 4, the information terminal 50 according to the present embodiment includes a communication unit 510, a control unit 530, and an operation display unit 540.

### Communication Unit 510

The communication unit 510 performs various types of communication with the server 30. For example, the communication unit 510 receives the notification of an offer for service provision from the server 30. Further, the communication unit 510 transmits a notification to the server 30 that the service provider U has responded to the offer based on operations by the service provider U.

### Control Unit 530

The control unit 530 controls the overall operation of the information terminal 50. For example, the control unit 530 controls transmission and reception of various kinds of information performed by the communication unit 510. For example, the control unit 530 causes the communication unit 510 to transmit information on the execution status of the currently determined service of the service provider U, which is input by the operation display unit 540, to the server 30.

### Operation Display Unit 540

The operation display unit 540 has a function as an operation unit that is capable of inputting information on the execution status of collection or delivery service of the package L by the service provider U. For example, the service provider U can respond to the notification of an offer for the service by operating the operation display unit 540. The operation to respond to the notification of an offer for the service may be, for example, an operation that presses an application button displayed on the operation display unit 540. The service provider U can also notify the server 30 of the start or completion of a determined service by operating the operation display unit 540. Alternatively, the service provider U can view information on services that are being offered or have been determined (the location of the package collection point, the travel route, or the like) by operating the operation display unit 540.

The function as the operation unit of the operation display unit 540 can be achieved, for example, by a touch panel or a keyboard, for example. Furthermore, the function as the display unit can be achieved by a cathode ray tube (CRT) display device, a liquid crystal display (LCD), or an organic light emitting diode (OLED) device. Note that the function as the display unit and the function as the operation unit may be configured separately.

The information terminal 50 may include a microphone, not illustrated in FIG. 4. In that case, the service provider U may use the microphone to voice-input the execution status regarding the service for delivery or collection of the package L. The information terminal 50 may further include a speaker, not illustrated in FIG. 4. In that case, the service provider U may check information on services by the voice output from the speaker.

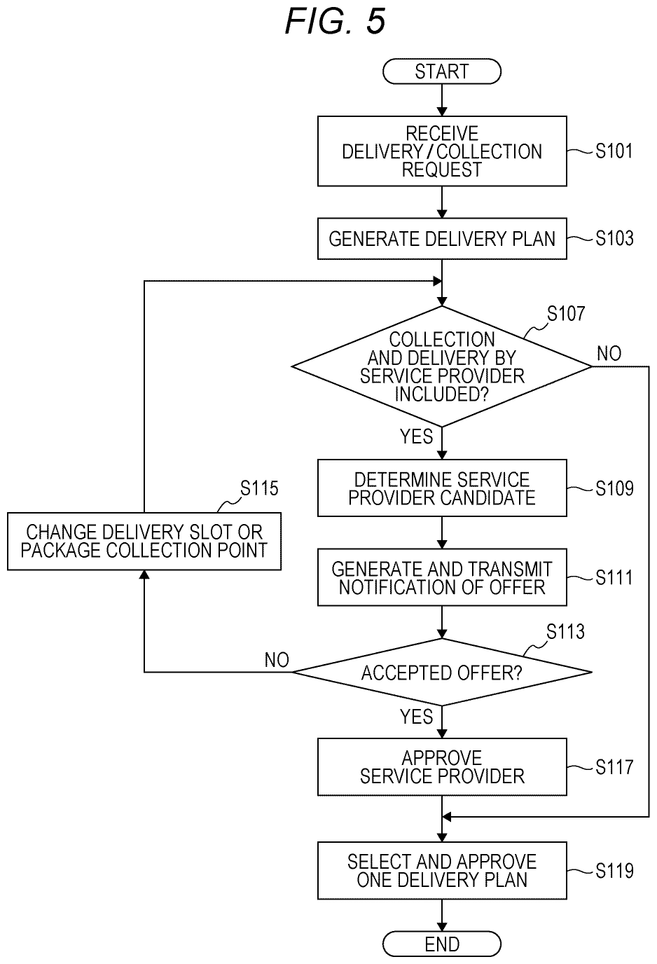

The functional configuration examples of the server 30 and the information terminal 50 are described heretofore with reference to FIGS. 3 and 4. Referring now to FIG. 5, an example of operation of the information processing system according to the present embodiment will be described.

### 3. Operation Example

FIG. 5 is a flowchart diagram for describing an operation processing example of determining service provider candidates and approving a delivery plan by the information processing system according to the present embodiment.

First, the communication unit 310 of the server 30 receives a request for delivery or collection of a package (delivery request) (S101). Upon reception of the delivery request, the control unit 330 of the server 30 generates delivery plans (S103). Note that among the delivery plans to be generated, for example, one or more delivery plans with shorter total delivery time or one or more delivery plans with lower total delivery cost may be stored as generated delivery plans in priority and then proceed to the next step.

If the generated delivery plans do not include a delivery plan that combines the collection and delivery of a package by the service provider with other delivery means (S107/NO), the control unit 330 selects and approves one of the generated delivery plans (S119). At this time, for example, the control unit 330 may select a delivery plan in which the delivery means is the unmanned vehicle 10A in preference to a delivery plan in which the delivery means is a delivery person using the manned mobile body 10B, from among the generated delivery plans. This makes it possible to promote the use of the unmanned vehicle 10A and to select a delivery plan with higher delivery efficiency. Further, instead of the determination in step S107, when the location of the delivery destination included in the delivery request is outside the predetermined range from the delivery start location of the mobile body 10 (for example, the warehouse WH, the current location of the mobile body 10, and a current responsible area) in step S103, a delivery plan may be generated in combination of delivery to a possible delivery point (relay point) by the delivery means with collection and delivery of the package by the service provider U from the possible delivery point to the delivery destination. In such a case, the step may proceed to step 109 without passing through step S107.

In S107, when the generated delivery plans include a delivery plan that combines the collection and delivery of the package by the service provider with other delivery means (S107/YES), the candidate determination unit 340 of the server 30 determines service provider candidates (S109). The notification generation unit 350 generates notification of an offer for the service. The control unit 330 causes the communication unit 310 to transmit the notification of the offer to the information terminal 50 used by the users determined as the candidates (S111).

If the users do not respond to the offer (S113/NO), the control unit 330 changes the originally designated delivery slot or package collection point in the delivery plan that combines the collection and delivery of the package by the service provider with other delivery means (S115). Next, the server 30 repeats the processes of S115, and S107 to S113 until any of the users responds to the offer for the service in S113. If none of the users respond to the offer for the service provision, matching of potential service providers will be performed again using the same delivery means and a different delivery slot or a package collection point. Note that if there is a time limit on the arrival time to the package delivery destination, the server 30 may repeat the processes of S115, and S107 to S113 within a certain limit number of times or a certain time limit within which the matching process can be repeated again until the user responds to the offer for the service. If the number of times the processes are repeated exceeds the limit number of times and the time limit, the server 30 may select another delivery plan that does not require the service provider to provide the service, or generate another new delivery plan and select and approve the other delivery plan.

When the user responds to the offer in S113 (S113/YES), the control unit 330 approves the user responded to the offer as the service provider (S117). At this time, the control unit 330 may cause the communication unit 310 to transmit notification of the determination to provide the service to the information terminal 50 used by the user.

The control unit 330 selects and approves one delivery plan, which is to the package collection point, combining the collection and delivery of the package L by the service provider with other delivery means (S119).

The operation processing example of determining service provider candidates and approving a delivery plan by the information processing system according to the present embodiment is described heretofore with reference to FIG. 5.

### 4. Hardware Configuration Example

The information processing described above is achieved through cooperation of software and hardware of the server 30 described below. Note that the hardware configuration described below is also applicable to the information terminal 50.

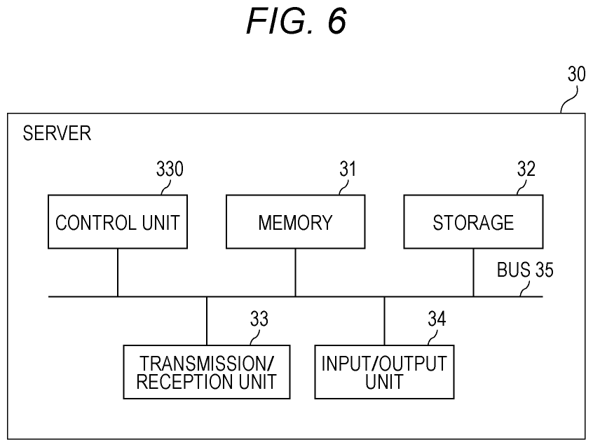

FIG. 6 is an explanatory diagram for describing an example of the hardware configuration of the server 30 according to the present embodiment. As illustrated in FIG. 6, for example, the server 30 includes a control unit 330, a memory 31, a storage 32, a transmission/reception unit 33, an input/output unit 34, and the like, which are electrically connected to each other via a bus 35.

The control unit 330 is an arithmetic device that controls the overall operation of the server 30, controls transmission and reception of data between each of the elements, executes applications, and performs information processing and the like necessary for authentication processing. For example, the control unit 330 is a central processing unit (CPU) and/or a graphics processing unit (GPU), which executes programs and the like for the system stored in the storage 32 and expanded on the memory 31 to perform various kinds of information processing as described above.

The memory 31 includes a main memory that is configured with a volatile storage device such as dynamic random access memory (DRAM) or the like, and an auxiliary memory that is configured with a non-volatile storage device such as a flash memory, a hard disc drive (HDD), or the like. The memory 31 is used as a work area and the like of the control unit 330, and also stores the basic input/output system (BIOS) executed when starting the server 30 as well as various kinds of setting information and the like.

The storage 32 stores various kinds of programs such as application programs and the like. A database that stores the data used for each kinds of processing may be built in the storage 32.

The transmission/reception unit 33 connects the server 30 to the network and/or blockchain network. Note that the transmission/reception unit 33 may include near field communication interfaces of Bluetooth (registered trademark) and Bluetooth Low Energy (BLE).

The input/output unit 34 is an information input device such as a keyboard, a microphone, a mouse, and the like and an output device such as a display, a speaker, and the like.

The bus 35 is commonly connected to each of the above elements and transmits, for example, address signals, data signals, and various kinds of control signals.

### 5. Supplement

The preferable embodiment of the present invention is described above in detail with reference to the accompanying drawings. However, the technical scope of the present invention is not limited to such examples. It is readily apparent to those having ordinary knowledge and skilled in the art to which the present disclosure belongs that various modifications and substitutions can be made without departing from the technical spirit and scope of the appended claims, and that those naturally fall within the technical scope of the present disclosure.

For example, in the above embodiment, the candidate determination unit 340 determines users estimated to be able to provide the service as service provider candidates based on a package collecting time zone at the package collection point, current locations of the users, travel means of the user, and determined schedule status for service provision of the users. However, the present invention is not limited to such examples. For example, the candidate determination unit 340 may have previously acquired possible conditions for service provision that indicate conditions under which each of the users is able to provide the service. The possible condition for service provision could be, for example, an area in which each user is able to collect and deliver packages, or a time zone in which the user is able to respond to the service without being notified of the offer. In this case, the candidate determination unit 340 may immediately approve a user who satisfies the possible condition for service provision, as the service provider, without notifying the users determined as the service provider candidates of the offer. This allows the control unit 330 to immediately approve one of the users as the service provider without standby for the user to respond to the offer. Accordingly, this can further reduce the time taking for approving the delivery plan generated by the control unit 330.

The steps in the process of operation of the server 30 and the information terminal 50 according to the present embodiment are not necessarily required to be processed chronologically according to the order described as the explanatory diagram. For example, each step in the process of operation of the server 30 and the information terminal 50 may be processed in a different order than that described as the explanatory diagram, or may be processed in parallel.

Effects described in the present specification are explanatory or exemplary but not restrictive. That is, the technique according to the present invention achieves, together with or in place of the above effects, any other effect that is obvious to those skilled in the art from the description of the present specification.

It is also possible to create a computer program for causing hardware such as a CPU, a ROM, a RAM, and the like built into the server 30 and the information terminal 50 to achieve the same functions as those of the server 30 and the information terminal 50 described above.

### REFERENCE SIGNS LIST

10 Mobile body

30 Server

310 Communication unit

320 Storage unit

330 Control unit

340 Candidate determination unit

350 Notification generation unit

50 Information terminal

510 Communication unit

530 Control unit

540 Operation display unit

1. An information processing system comprising:
a control unit that generates one or more delivery plans including delivery routes and delivery means of a package; and
a candidate determination unit that determines, as candidates of a service provider, one or more users estimated to be able to provide a service for collection and delivery of the package, wherein
upon approval of one user, as the service provider, from among the users determined as the candidates, the control unit selects and approves one of the delivery plans to a package collection point of the service provider from among the generated delivery plans.

2. The information processing system according to claim 1, further comprising
a notification generation unit that generates notification of an offer for the service provider, wherein
the control unit approves the user determined as the candidate, as a service provider, based on response of the user to the offer.

3. The information processing system according to claim 1, wherein
the control unit acquires a possible condition for service provision that indicates a condition in a state where each of the users is able to perform service provision, and
selects a user satisfying the possible condition for service provision from among the users determined as the candidates and approves the user as the service provider.

4. The information processing system according to claim 1, wherein the candidate determination unit determines users estimated to be able to provide the service as service provider candidates based on a package collecting time zone at the package collection point, current locations of the users, travel means of the users, and determined schedule status for service provision of the users.

5. The information processing system according to claim 4, wherein
the candidate determination unit estimates locations of the users by time and travel routes of the users from the current locations to the package collection point based on the current locations and the determined schedule status for service provision of the users, and
determines one or more users estimated to be able to provide the service as service provider candidates based on the estimated locations and the estimated travel routes of the users.

6. The information processing system according to claim 5, wherein the candidate determination unit determines one or more of the users in order of shorter travel route to the package collection point as the service provider candidates from among the users estimated to be able to travel to the package collection point within the package collecting time zone and to be able to perform delivery of the package to a destination.

7. The information processing system according to claim 5, wherein the candidate determination unit determines one or more of the users in order of earliest estimated arrival time to the package collection point as the service provider candidates from among the users estimated to be able to travel to the package collection point within the package collecting time zone and to be able to perform delivery of the package to a destination.

8. The information processing system according to claim 5, wherein
the candidate determination unit acquires a possible standby time indicating a time period that allows the package to stand by at the package collection point, determined based on a control temperature zone of the package, and
determines the users estimated to be able to arrive at the package collection point within a time period between an estimated arrival time of the package at the package collection point and elapse of the possible standby time, as the service provider candidates.

9. The information processing system according to claim 6, further comprising
a notification generation unit that generates notification of an offer for the service provider, wherein
the control unit notifies one user, from among the users determined as the candidates, of the offer.

10. The information processing system according to claim 6, further comprising
a notification generation unit that generates notification of an offer for the service provider, wherein
the control unit notifies one or more predetermined number of users, from among the users determined as the candidates, of the offer.

11. The information processing system according to claim 10, wherein the control unit approves one of the users who responded to the offer at earliest, as the service provider, from among the users determined as the candidates and notified of the offer.

12. The information processing system according to claim 11, wherein the control unit approves the user who responded to the offer within a certain time period after notification of the offer, as the service provider.

13. The information processing system according to claim 12, wherein
when none of the users respond to the offer within a certain time period after notification of the offer, the candidate determination unit determines the service provider candidate for another delivery plan from which the package collection point and the package collecting time zone are different, and
the control unit approves the user determined as the candidate, as a service provider, based on response of the user to the offer.

14. The information processing system according to claim 12, wherein when none of the users respond to the offer within a certain time period after notification of the offer, the control unit selects and approves another delivery plan that does not include collection and delivery of the package by the service provider.

15. The information processing system according to claim 13, wherein
the control unit acquires availability of delivery slots divided by predetermined time slots indicating time zones in which delivery by the delivery means is possible, and possible delivery locations indicating a point where delivery by the delivery means is possible, and
generates the delivery plan by designating the delivery means, the delivery slot, the possible delivery location, and the delivery route based on availability of the delivery slots and the possible delivery locations in each of the delivery means.

16. The information processing system according to claim 15, wherein the control unit generates the delivery plan based on a weather forecast for the delivery route.

17. The information processing system according to claim 16, wherein the delivery means includes an unmanned vehicle.

18. The information processing system according to claim 17, wherein the unmanned vehicle includes a mobile body that autonomously travels on a land route or an aircraft that autonomously flies on an air route.

19. An information processing device including:
a control unit that generates one or more delivery plans including delivery routes and delivery means of a package; and
a candidate determination unit that determines, as candidates of a service provider, one or more users estimated to be able to provide a service for collection and delivery of the package, in which
upon approval of one user, as the service provider, from among the users determined as the candidates, the control unit selects and approves one of the delivery plans to a package collection point of the service provider from among the generated delivery plans.

20. An information processing method executed by a computer, the information processing method including:
generating one or more delivery plans including delivery routes and delivery means of a package;
determining, as candidates of a service provider, one or more users estimated to be able to provide a service for collection and delivery of the package; and
selecting and approving one of the delivery plans to a package collection point of the service provider from among the generated delivery plans upon approval of one user, as the service provider, from among the users determined as the candidates.

21. A program that causes a computer to function as the computer including:
a control unit that generates one or more delivery plans including delivery routes and delivery means of a package; and
a candidate determination unit that determines, as candidates of a service provider, one or more users estimated to be able to provide a service for collection and delivery of the package, in which
upon approval of one user, as the service provider, from among the users determined as the candidates, the control unit selects and approves one of the delivery plans to a package collection point of the service provider from among the generated delivery plans.
